(19) United States
(12) Patent Application Publication
(10) Pub. No.: US 2023/0250034 A1
(43) Pub. Date: Aug. 10, 2023

(54) METHOD FOR MANUFACTURING AN ENVIRONMENTAL BARRIER

(71) Applicant: SAFRAN CERAMICS, LE HAILLAN (FR)

(72) Inventors: Lisa PIN, Moissy-Cramayel (FR); Luc Patrice BIANCHI, Moissy-Cramayel (FR); Sophie Olivia Michele BOUDET, Moissy-Cramayel (FR); Jimmy James MARTHE, Moissy-Cramayel (FR)

(73) Assignee: SAFRAN CERAMICS, LE HAILLAN (FR)

(21) Appl. No.: 18/003,042

(22) PCT Filed: Jun. 22, 2021
(86) PCT No.: PCT/FR2021/051139

§ 371 Date: Dec. 22, 2022

(30) Foreign Application Priority Data
Jul. 2, 2020 (FR) FR2007018

(51) Int. Cl. C04B 41/89; C04B 41/52; C04B 35/622; C04B 41/00; C04B 35/628; C04B 35/16; C23C 4/10; C23C 4/18

(52) U.S. Cl. CPC C04B 41/89; C04B 41/52; C04B 35/62222; C04B 41/009; C04B 35/62815; C04B 35/62884; C04B 35/62886; C04B 35/16; C23C 4/10; C23C 4/18; C04B 2235/3225; C04B 2235/3224

(57) ABSTRACT

A method for manufacturing an environmental barrier comprising the steps of coating a rare earth silicate powder with a precursor of a densification agent in order to form a rare earth silicate powder coated with the precursor of the densification agent, thermally spraying the coated powder onto a substrate in order to obtain an at least partially amorphous environmental barrier on the substrate and thermally treating the environmental barrier in order to crystallize and densify the environmental barrier.

### TECHNICAL FIELD

The present disclosure relates to environmental barriers, also called “EBC)”, in accordance with the acronym for “Environmental Barrier Coating”, and their manufacturing method.

### PRIOR ART

An environmental barrier for a CMC (ceramic matrix composite) part of a turbomachine is known from FR3059323.

The CMC part can for example be a turbine part of a turbomachine. The turbomachine can for example be a turbojet engine.

Under the operating conditions of aeronautical turbines, for example high temperature and corrosive environment, CMCs are generally sensitive to corrosion. The corrosion of CMC generally results in the oxidation of silicon carbide to silica. In the presence of water vapor, silica volatilizes in the form of Si(OH)₄ hydroxides. These corrosion phenomena lead to premature degradation of the CMC. Also, in order to guarantee the service life of the CMCs, the CMCs are protected against wet corrosion by an environmental barrier (EBC).

EBCs are usually prepared by thermal spraying. However, this method generally produces a coating comprising a set of defects generating a 3D network of porosity/cracks which adversely affect the performance of the EBC.

On the other hand, it has been demonstrated that the effectiveness of an EBC was intimately related to its hermeticity, in order to block the molecular diffusion of oxidizing and corrosive species.

Various solutions exist for improving the sealing of one or more layers of an EBC, such as the addition of sintering agents or healing agents. However, it can be complicated to obtain a homogeneous distribution of the sintering and/or healing agents.

### DISCLOSURE OF INVENTION

The present disclosure aims at overcoming these disadvantages at least in part.

This disclosure relates to a method for manufacturing an environmental barrier, the method including the following steps: coating a rare earth silicate powder with a precursor of a densification agent in order to form a rare earth silicate powder coated with the precursor of the densification agent;

thermally spraying the coated powder onto a substrate in order to obtain an at least partially amorphous environmental barrier on the substrate; and thermally treating the environmental barrier in order to crystallize and densify the environmental barrier.

Thanks to the coating of the rare earth silicate powder with a precursor of a densification agent, the precursor of the densification agent, and therefore the densification agent, is distributed homogeneously.

It is understood that the coating of the rare earth silicate powder with a precursor of the densification agent allows to obtain better distribution and better control of the dosage of the densification agent than conventional mixing/grinding methods. The method allows to obtain a homogeneous distribution and in very finely dispersed form of the densification agent in the matrix of rare earth silicate powder.

During thermal spraying, the precursor of the densification agent will react to form the densification agent on the rare earth silicate powder and promote the densification of the environmental barrier. Therefore, it can be considered to reduce the mass content of the densification agent compared to a mixture obtained by mixing/grinding the two powders together.

By way of non-limiting examples, the densification agent obtained during the thermal spraying of the coated powder may be magnesium oxide, calcium oxide, iron oxide, yttrium oxide, mullite, silica.

In some embodiments, the thermal spraying may be air plasma spraying, vacuum plasma spraying or HVOF in accordance with the acronym for “High Velocity Oxy Fuel”.

In some embodiments, the coating may be carried out by wet process.

In some embodiments, the rare earth silicate powder may be immersed in a solution comprising a solvent and the precursor of the densification agent, the solvent may be evaporated to form an agglomerated coated powder, and the agglomerated coated powder may be deagglomerated to form the coated powder.

In some embodiments, the deagglomeration of the agglomerated powder may comprise a step of thermally treating the agglomerated powder at a temperature comprised between 250° C. (degrees Celsius) and 600° C. for 1 h (hour) to 4 h.

In some embodiments, the rare earth silicate powder may be fluidized in a solution comprising a solvent and the precursor of the densification agent.

In some embodiments, the coating may be carried out by gas process.

In some embodiments, the precursor of the densification agent may be an organometallic precursor.

By way of non-limiting examples, the organometallic precursor may be a metal nitrate, a metal acetate, a metal chloride, a metal alkoxide or a metal phosphorus.

By way of non-limiting example, the organometallic precursor may be a metal salt of magnesium, iron, aluminum and/or silicon and/or aluminophosphate and/or a magnesia sol, iron oxide, boehmite, silica.

The use of a metal salt allows to reduce the loss of silica during the thermal spraying of a rare earth silicate powder by the preferential oxidation of the metal salt which is placed outside the particle. The oxidizing species of the plasma will therefore react preferentially with the metal salt and form a protective oxide gangue around the rare earth silicate powder, thus limiting the volatilization of the silica.

In some embodiments, the precursor of the densification agent may be the densification agent.

By way of non-limiting examples, the precursor of the densification agent may be magnesium oxide or silica, the densification agent being the same as the precursor.

When silica is present as a precursor of the densification agent, the silica present in the outer layer of the powder particles will “saturate” the plasma and thus avoid or reduce the volatilization of the silica present in the powder of rare earth silicate.

In some embodiments, the coated powder may have a core-shell structure.

It is possible to obtain a core-shell structure, in which the powder particles comprise a core of rare earth silicate powder coated by an outer layer (or shell) formed by the precursor of the densification agent. The shell may have a thickness of the order of a nanometer and the distribution of the precursor of the sintering agent as well as the control of the dosage of the precursor of the sintering agent are improved.

In some embodiments, the heat treatment may be carried out at a temperature greater than or equal to 1100° C., preferably greater than or equal to 1200° C. and less than or equal to 1350° C., preferably less than or equal to 1300° C. with a plateau greater than or equal to 5 h and less than or equal to 50 h.

In some embodiments, the substrate may be a ceramic matrix composite material substrate.

The CMC material substrate is generally made from ceramic fibers woven in 2D or 3D. These ceramic fibers may then be subjected to gaseous densification (also called “CVI” according to the acronym for “Chemical Vapor Infiltration”), alone or in combination with another technique, such as Melt Infiltration (also called “MI”) in order to obtain the substrate made of CMC material.

In some embodiments, the environmental barrier may comprise a bonding layer.

By way of non-limiting examples, the bonding layer may be made of silicon.

It is understood that the bonding layer is deposited on the substrate and is comprised between the substrate and the material layer.

### BRIEF DESCRIPTION OF THE DRAWINGS

Other characteristics and advantages of the object of this presentation will emerge from the following description of embodiments, given by way of non-limiting examples, with reference to the appended figures.

FIG. 1 is a schematic sectional view of a substrate and an environmental barrier according to one embodiment.

FIG. 2 is a schematic sectional view of a substrate and an environmental barrier according to a detailed embodiment.

FIG. 3 is a schematic sectional view of a coated powder according to one embodiment.

FIG. 4 is a schematic sectional view of a coated powder according to another embodiment.

FIG. 5 is a flowchart representing the steps of a method for manufacturing an environmental barrier.

In all the figures, the elements in common are identified by identical reference numerals.

### DETAILED DESCRIPTION

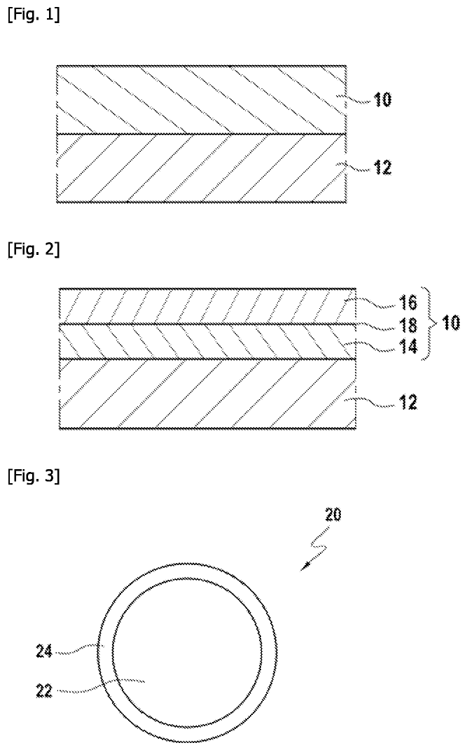

FIG. 1 is a schematic representation of a substrate 12 covered with an environmental barrier 10.

By way of non-limiting example, the substrate 12 may be a ceramic matrix composite material substrate.

By way of non-limiting example and as shown schematically in FIG. 2, the environmental barrier 10 may comprise a silicon bonding layer 14 and an yttrium disilicate layer 16.

At the interface between the bonding layer 14 and the yttrium disilicate layer 16 there is a silica layer 18. The silica layer 18 is a layer of silicon oxide formed by oxidation of the silicon bonding layer 14.

The yttrium disilicate layer 16 comprises a densification agent.

By way of non-limiting examples, the densification agent may be a sintering agent and/or a healing agent.

By way of non-limiting examples, the sintering agent may be magnesium oxide, iron oxide.

By way of non-limiting example, the healing agent is mullite, silica or an aluminophosphate.

By way of non-limiting example, the yttrium disilicate layer 16 may comprise between 0.1 and 5% by mass of sintering agent, for example 0.4% by mass of sintering agent.

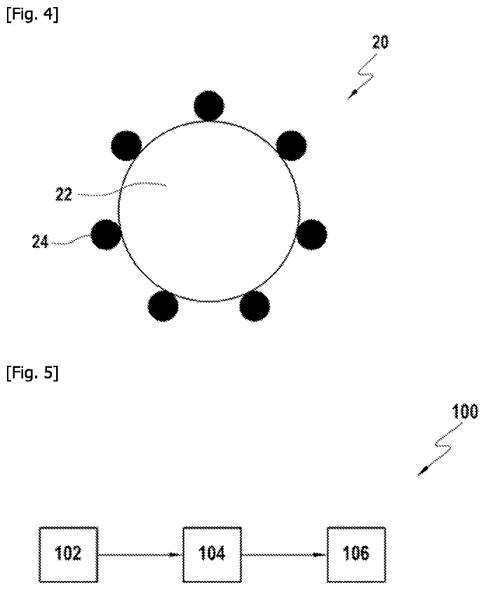

The environmental barrier 10 may be obtained by the manufacturing method 100 of FIG. 4.

The method 100 for manufacturing the environmental barrier 10 comprises a step of coating 102 a rare earth silicate powder 22 with a precursor of a densification agent 24 to form a rare earth silicate powder 20 coated with the precursor of the densification agent.

The coated powder 20 may have a core-shell structure, as shown in FIG. 3, the coated powder 20 comprising a core of rare earth silicate powder 22 coated by an outer layer (or shell) formed by the precursor of the densification agent 24.

Alternatively, the coated powder 20 may have particles formed by the precursor of the densification agent 24 present on the surface of the rare earth silicate powder 22, as shown in FIG. 4.

These two types of structures may be obtained by the wet process or by the gas process.

### Example of Coating

Rare earth disilicate powder, magnesium acetate and distilled water.

In 1 L (liter) of distilled water, dissolve 5% by mass of magnesium acetate (typically between 0.1 and 10% by mass).

Pour 1 kg of rare earth disilicate powder into the aqueous solution of magnesium acetate.

Mix with a magnetic bar.

Drying at 90° C. in an oven.

On the blocks of agglomerated powder, perform a heat treatment at 400° C. for 1 hour in air so that the blocks become brittle.

The coated powder 20 is available.

The coated powder 20 is sprayed by a thermal spraying method 104 onto the substrate 12 in order to obtain an environmental barrier 10 that is at least partially amorphous onto the substrate 12.

In the example of the organometallic precursor of the densification agent described above, the organometallic precursor of the densification agent, that is to say magnesium acetate, will dehydrate and oxidize during thermal spraying to form the densification agent around the rare earth disilicate powder, in a desired and controlled concentration. A partially amorphous environmental barrier 10 may be obtained with flattened grains (also called “splats”) of rare earth disilicate and the densification agent evenly distributed around the flattened grains of rare earth disilicate.

The environmental barrier 10 then undergoes a heat treatment step 106 in order to crystallize and densify the environmental barrier.

As a non-limiting example, the crystallization and densification heat treatment 106 may comprise a temperature rise at 100° C./h (degrees Celsius per hour) up to 1300° C., a plateau of 50 hours at 1300° C. and a temperature drop at 100° C./h and down to room temperature, that is to say around 20° C.

As a non-limiting example, the crystallization and densification heat treatment 106 may comprise a temperature rise at 300° C./h (degrees Celsius per hour) up to 1350° C., a plateau of 5 hours at 1350° C. and a temperature drop at 100° C./h and down to room temperature, that is to say around 20° C.

Although this presentation has been described with reference to a specific embodiment, it is obvious that various modifications and changes can be made to these examples without departing from the general scope of the invention as defined by the claims. Furthermore, individual features of the various embodiments discussed may be combined in additional embodiments. Accordingly, the description and the drawings should be considered in an illustrative rather than restrictive sense.

1. A method for manufacturing an environmental barrier, the method comprising the following steps:
coating a rare earth silicate powder with a precursor of a densification agent in order to form a rare earth silicate powder coated with the precursor of the densification agent;
thermally spraying the coated powder onto a substrate in order to obtain an at least partially amorphous environmental barrier on the substrate; and
thermally treating the environmental barrier in order to crystallize and densify the environmental barrier.

2. The manufacturing method according to claim 1, wherein the coating is carried out by wet process.

3. The manufacturing method according to claim 2, wherein the rare earth silicate powder is immersed in a solution comprising a solvent and the precursor of the densification agent, the solvent is evaporated to form an agglomerated coated powder, and the agglomerated coated powder is deagglomerated to form the coated powder.

4. The manufacturing method according to claim 2, wherein the rare earth silicate powder is fluidized in a solution comprising a solvent and the precursor of the densification agent.

5. The manufacturing method according to claim 1, wherein the coating is carried out by gas process.

6. The manufacturing method according to claim 1, wherein the precursor of the densification agent is an organometallic precursor.

7. The manufacturing method according to claim 1, wherein the coated powder has a core-shell structure.

8. The manufacturing method according to claim 1, wherein the substrate is a ceramic matrix composite material substrate.

9. The manufacturing method according to claim 1, wherein the environmental barrier comprises a bonding layer.
